(19) United States
(12) Patent Application Publication
(10) Pub. No.: US 2026/0320044 A1
(43) Pub. Date: Oct. 15, 2026

(54) SYSTEMS AND METHODS FOR PRE-AGGREGATING DATA BY STATIC ANALYSIS OF QUERIES

(71) Applicant: Capital One Services, LLC, McLean, VA (US)

(72) Inventor: Andrew TALLEY, Nashville, TN (US)

(73) Assignee: Capital One Services, LLC, McLean, VA (US)

(21) Appl. No.: 19/176,417

(22) Filed: Apr. 11, 2025

(51) Int. Cl. G06F 16/2453

(52) U.S. Cl. CPC G06F 16/24535; G06F 16/24537

(57) ABSTRACT

A method of generating a first sub-query and a second sub-query based on a received query. A query analyzation module may determine whether the query includes one or more functions, and one or more user provided variables associated with the one or more functions. The query analyzation module may modify the query by removing the one or more user provided variables from the query. Based on the modified query, the query analyzation module may generate a first sub-query and a second sub-query. The first sub-query may comprise instructions to generate a partitioned data and calculated intermediate results. The second sub-query may contain the user provided variables. The query analyzation module may generate final results by executing the second sub-query then output the final results to the query.

### TECHNICAL FIELD

Various embodiments of this disclosure relate generally to techniques for optimizing queries containing variables to minimize processing time and reduce data transfer size, and, more particularly, to systems and methods for pre-aggregating data by static analysis of queries.

### BACKGROUND

As the volume of data generated by large-scale systems grows, executing queries on these databases demands significantly more time and computational resources. To address this challenge, various techniques have been developed to alleviate the overwhelming data influx. For example, in some cases databases are presorted to enable a quicker search. However, these conventional techniques fail to provide automatic pre-aggregation queries based on variables and are incapable of processing complex requests. Further, standard approaches fail to provide techniques for reducing data transmission load when processing complex queries.

This disclosure is directed to addressing challenges such as one or more of those referenced above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for optimized query processing, including automatic pre-aggregation of data containing variable parameters. A query analyzation module may analyze the query for one or more functions and one or more user provided variables associated with the one or more functions. For each of the one or more functions, the query analyzation module may determine a function type, wherein the function type may include one of a first function type, a second function type, or a third function type. Based on the one or more functions and function types, the query analyzation module may generate a first sub-query and a second sub-query. The first sub-query may partition data dependent on the one or more functions, and information associated with the one or more functions, and generate intermediate results. The second sub-query may contain the user provided variables and generate final results as output to the query.

In some aspects, the techniques described herein relate to a method including: determining, based on receiving a query, one or more user provided variables located in the query; generating, based on determining the one or more user provided variables, a first sub-query and a second sub-query by: modifying the query to remove the one or more user provided variables; generating, based on analyzing the modified query, the first sub-query, wherein the first sub-query includes instructions to retrieve a partitioned data set with pre-calculated intermediate results; and generating, based on generating the first sub-query, the second sub-query, wherein the second sub-query includes the removed user provided variables; receiving, based on executing the first sub-query, the intermediate results from the partitioned data set; and based on executing the second sub-query and based on the intermediate results, providing output to the query.

In some aspects, the techniques described herein relate to a method including: determining, based on receiving a query, that the query includes one or more user provided variables; generating, based on determining the one or more user provided variables, a first sub-query and a second sub-query by: modifying the query to remove the one or more user provided variables; determining, based on analyzing the modified query, a first data set associated with the one or more user provided variables; partitioning, based on determining the first data set, the first data set; generating, based on analyzing the modified query, the first sub-query, wherein the first sub-query includes instructions to retrieve the partitioned data set and to calculate intermediate results with the first data set; and generating, based on generating the first sub-query, the second sub-query, wherein the second sub-query includes the removed user provided variables; generating, based on executing the first sub-query, the intermediate results; and based on executing the second sub-query, providing output to the query.

In some aspects, the techniques described herein relate to a computing system, including: a processor; and a memory having programming instructions stored thereon, which, when executed by the processor, cause the computing system to perform operations including: determining, based on receiving a Structured Query Language (SQL) query and based on a first machine-learning model, one or more user provided variables located in the query; generating, based on determining the one or more user provided variables located in the query and based on a second machine-learning model, a first sub-query and a second sub-query by: modifying the query by removing the one or more user provided variables; generating, based on the modified query, the first sub-query, wherein the first sub-query includes instructions to partition a data set; and generating, based on generating the first sub-query, the second sub-query, wherein the second sub-query includes the removed user provided variables; generating, based on executing the first sub-query, a partitioned data set; generating, based on generating the partitioned data set, intermediate results; and based on executing the second sub-query and based on generating the intermediate results, providing output to the query.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment, according to one or more embodiments.

FIG. 2 depicts a flowchart of an exemplary method of optimizing a query, according to one or more embodiments.

FIG. 3 depicts a flowchart of an exemplary method of generating sub-queries, according to one or more embodiments.

FIG. 4 depicts a flowchart of an exemplary method of generating partitioned data and intermediate results, according to one or more embodiments.

FIG. 5 depicts a flowchart of an exemplary method of generating final results, according to one or more embodiments.

FIG. 6 depicts an example of a computing device, according to one or more embodiments.

### DETAILED DESCRIPTION OF EMBODIMENTS

According to certain aspects of the disclosure, methods and systems are disclosed for automatically pre-aggregating data. Executing queries on large databases may result in high latency and generate a significant volume of data to be transferred across a network. However, conventional techniques may not be suitable. For example, conventional techniques may not dynamically and automatically pre-aggregate data based on information from a received query, such as information associated with user provided variables. Accordingly, improvements in technology relating to automatically pre-aggregating data based on variables are needed. In doing so, the query analyzation module may provide for dynamically creating new schemas for each unique query.

The method further described below may provide for creating intelligent data partitions, executing a query per partition ahead of runtime, and joining the results of selected partitions during runtime. For example, the query analyzation module may analyze a query, such as an SQL query, and automatically generate a first sub-query and a second sub-query based on whether the query includes one or more user provided variables. The first sub-query may retrieve automatically generated partitioned data and calculate intermediate results by, for example, calculating all distributive functions for each partition. The second sub-query may receive the partitioned data or the calculated intermediate results, filter out nonrelevant partitioned data or results based on the one or more user provided variables, and merge resulting distributive functions into a final calculation (final results). Dividing the original query into two sub-queries then executing the two sub-queries may result in the same correct outcome as executing the original query. However, such a method will use less processing resources and produce a faster output.

As will be discussed further below, in various embodiments, systems and methods are described for partitioning data sets prior to a run-time (a second sub-query). Partitioning large data sets before running the second sub-query may result in processing larger data sets more efficiently. The method may employ distributive and algebraic functions to distribute computing and data across multiple nodes. The query analyzation module may provide for ahead-of-time query optimization and may apply to single-table and multi-table approaches.

As will be discussed in more detail below, in various embodiments, systems and methods are described for analyzing and optimizing data requests, such as SQL queries. When receiving a request, the query analyzation module may analyze the request to determine whether the request contains functions that filter data. In SQL, these functions may include clauses such as WHERE, SELECT, FROM, GROUP BY, HAVING, ORDER BY, LIMIT, OFFSET and other similar clauses. Additionally, the functions may include operators, such as BETWEEN, IN, LIKE, and similar operations. Further, the functions may include algebraic functions like SUM, COUNT, AVERAGE, and similar algebraic functions.

The query analyzation module may determine that the request comprises one or more functions that filter data. The one or more functions may include one or more clauses. The one or more clauses may be divided into multiple, independently evaluated expressions. For each expression, the query analyzation module may determine data, e.g., columns in a database, that depend upon the clause. The query analyzation module may mark the data (e.g., columns) as partitions of the data and save the markings (e.g., column information) or the data in a unique location. In this way, information may be saved to/within a datastore, one or more tables, one or more databases, one or more spreadsheets, or similar storage element. The query analyzation module may then calculate intermediate results for each partition. The intermediate results may be stored in a datastore. When executing the second sub-query, the query analyzation module may identify relevant partitions. The query analyzation module may retrieve the relevant partitions and join the partitions to calculate the final result. Additionally or alternatively, the query analyzation module may retrieve pre-calculated intermediate results. Hence, partitioning the data permits aggressively aggregating data without limiting the functionality of the query.

Each of the one or more functions located in the query may be associated with a clause. Each clause may contain a variable that may be unique to each user (a user provided variable). After determining that a clause contains a user provided variable, the query analyzation module may generate a modified query by removing the user provided variable. The query analyzation module may generate a first sub-query based on the generated modified query. Alternatively, the query analyzation module may generate the first sub-query based upon the original query. Upon execution, the first sub-query may determine data dependent on the clause, e.g., from one or more databases associated with the clause. Based on determining the data, the first sub-query may partition the data. Partitioning the data may include marking the data for partitioning. Alternatively or additionally, the first sub-query may identify previously partitioned data in one or more databases associated with the one or more functions. The query analyzation module may generate intermediate results based on the partitioned data and store the intermediate results in a datastore, a library, or the like. Additionally or alternatively, the query analyzation module may retrieve previously generated intermediate results saved in a datastore based on previously partitioned data stored in the datastore.

Based on partitioning the data, the query analyzation module may calculate intermediate results. For example, the query analyzation module may find all aggregate functions within the SQL query (e.g., the average of a column). The query analyzation module may then calculate intermediate results by saving data in a format that may be later joined into a final calculation. In some instances, the query analyzation module may calculate the distributive components of all aggregate queries. These intermediate results may be calculated ahead of time and stored in a datastore. These intermediate results may be a significantly smaller size than an original data set. For example, the intermediate results may be between 10% to 99% smaller than the original, pre-partitioned data set.

Based on generating the first sub-query, the query analyzation module may generate a second sub-query containing the one or more user provided variables. When executed, the second sub-query may filter out irrelevant partitions based on the one or more user provided variables. Additionally, the second sub-query may join the remainder of the partitioned data. The query analyzation module may aggregate the intermediate results and calculate the final result as output for the query.

The method additionally permits automatic pre-aggregation and execution of queries (such as SQL queries) while still retaining complete control and the ability to use the variables in the query at run time. The query analyzation module may further allow for completely pre-executing queries without variables, eliminating all unused columns, aggregating a theoretically maximum number of fields before a runtime (second sub-query), and supporting the use of variables in sub-queries and nested queries. Additionally, the query analyzation module may operate transparently to a developer, allowing the developer to provide a simple SQL query and permitting live query monitoring. Combined, these techniques may allow users (including developers) to dramatically speed up queries without losing significant flexibility.

As will be discussed in more detail below, in various embodiments, systems and methods are described for statically analyzing a query to determine which query functions (clauses) are affected by the use of variables. Then, based on the query functions, the query analyzation module may determine which data (e.g., columns) depend on those functions. The query analyzation module may create two sub-queries: a first sub-query and a second sub-query. The first sub-query may comprise instructions to pre-aggregate the data or retrieve previously pre-aggregated data, and to calculate intermediate results with the data. The second sub-query may comprise the user provided variables and instructions to generate final results with the user provided variables.

This method may create intelligent partitions. The query analyzation module may execute a sub-query per partition before runtime and join the results of the selected partitions at runtime. This method may employ three different types of distributed aggregate functions: distributive, algebraic, and holistic.

A function is distributive if that function may be executed on each partition of a data set and supply the correct value when aggregating all of them. The SUM clause and the COUNT clause may be distributive. For example, a bag of data B composed of multiple partitional distributive functions may be formally defined as a function F such that there is some function G such that F(B)=G(F(B1), F(B2), . . . . F(BN)). Here, both F and G would be SUM. The clause COUNT may be run on intermediate results, and the result may be the number of partitions.

An algebraic function may be defined as a function F that has a single function G that takes a finite number of arguments H that are each a distributive function. For example, AVERAGE may be an algebraic function. Calculating AVERAGE may entail calculating both the SUM and COUNT of each partition, aggregate the results, and divide the total sum by the total count.

A holistic function may be described as a function that cannot be derived by performing a finite number of distributive functions on each partition. For example, MEDIAN may be a holistic function. To calculate MEDIAN, every value may need to be available. Hence, the whole data may need to be available within a single node to calculate the median for the data set B1 . . . . BN.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine-learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration. By virtue of such training, a machine-learning model is converted from an un-trained and un-specific model to a model that is unique to and specifically configured for the particular purpose for which it is trained. In an example, training of a machine-learning model is analogous to a method of production in which the article produced is the trained model having unique characteristics by virtue of its particular training. Moreover, the result of training a machine-learning model using particular training data for a particular purpose results in a technical solution to an inherently technical problem.

The execution of the machine-learning model may include deployment of one or more machine-learning techniques, such as linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

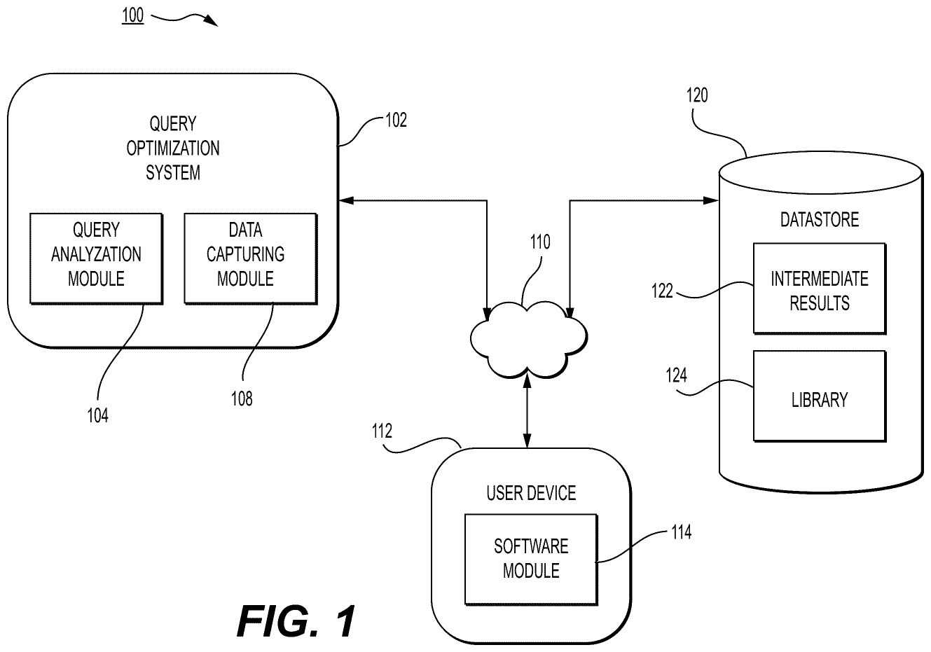

FIG. 1 depicts an exemplary environment 100 that may be utilized with techniques presented herein. One or more user devices 112 may communicate across an electronic network 110. As will be discussed in further detail below, query optimization system 102 may communicate with one or more of the other components of the environment 100 across electronic network 110. The one or more user devices 112 may be associated with one or more users, e.g., a user associated with the writing or running/executing of a query or a user associated with one or more of generating, training, or tuning a machine-learning model for query optimization. As described, the one or more user devices 112 may be associated with one or more users that are interacting with, or interfacing with, a database or enterprise system, by query, dashboards, alerts, lookups, or the like, via user device 112.

In some embodiments, the components of the environment 100 may be associated with a common entity, e.g., a financial institution, a database system, an enterprise system, a developer environment, a programing environment, an administrator of any of the same, or the like. In some embodiments, one or more of the components of the environment may be associated with a different entity than another. The systems and devices of the environment 100 may communicate in any arrangement. As will be discussed herein, systems or devices of the environment 100 may communicate in order to one or more of generate, train, or use a machine-learning model to identify associations between database queries and query execution overhead data, or output a query execution score, among other activities.

The user device 112 may be configured to enable a user to access or interact with other systems in the environment 100. For example, the user device 112 may be a computer system such as, for example, a desktop computer, a mobile device, a tablet, etc. In some embodiments, the user device 112 may include one or more electronic application(s), e.g., a program, interface, plugin, browser extension, etc., installed on a memory of the user device 112. In some embodiments, the electronic application(s) may be associated with one or more of the other components in the environment 100. For example, the electronic application(s) may include one or more of database system software, user interface, etc.

The user device 112 may include software module 114. Software module 114 may include a program, interface, plugin, application programming interface (API), browser extension, or the like. In various embodiments, query optimization system 102 may be implemented or run on user device 112 using software module 114. In any case, software module 114 may capture a proposed database query via an input/output interface of user device 112. Software module 114 may allow the user to “submit” or “test” the proposed database query, which may trigger a transmission of the proposed database query to data capturing module 108 of query optimization system 102. In examples, submitting the proposed database query via software module 114 results in the proposed database query not being executed upon a live database system, but instead may allow data capturing module 108 to capture the proposed database query, and may further allow query optimization system 102 to run the proposed database query on, for example, a test database. In an example, data capturing module 108 is configured to intercept, e.g., act as a man-in-the-middle for, a query entered by the user via the software module 114.

In various implementations, the environment may include a datastore 120. Datastore 120 may act as a database for query optimization system 102 as a repository or source for storing database queries, intermediate results 122, final results, user profile data, historical data, or any other data allowing query optimization system 102 to perform or determine any aspects described herein. Datastore 120 may contain one or more libraries, such as library 124.

In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may refer to connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like.

As depicted in FIG. 1, query optimization system 102 may include query analyzation module 104. Query analyzation module 104 may include one or more machine learning models. In various embodiments, query analyzation module 104 is configured to optimize a query by generating at least a first sub-query and a second sub-query based on the query. Query analyzation module 104 may generate one or more first sub-queries and one or more second sub-queries for each query analyzed. Query analyzation module 104 may generate the first sub-query with instructions to determine intermediate results based on analyzing partitioned data. The partitioned data may include data dependent upon one or more functions associated with the query. Query analyzation module 104 may configure the second sub-query to generate final results based on one or more user provided variables in the query. Each of the one or more user provided variables may be associated with a function of the query. Query analyzation module 104 may output final results by generating a table, spreadsheet, database, or the like, customized for the final results. By executing the first sub-query on partitioned data associated with the query then executing the second sub-query, where the second sub-query contains one or more user provided variables, query analyzation module 104 may minimize processing time and reduce data transfer size.

As will be described in more detail below, query analyzation module 104 may determine whether and how the query may be optimized. In various implementations, query analyzation module 104 may determine that the query may be optimized by identifying one or more functions that filter data. For example, query analyzation module 104 may employ Natural Language Processing (NLP) to identify and analyze one or more functions that filter data. In some instances, query analyzation module 104 may determine whether each of the one or more functions is a distributive function, an algebraic function, or a holistic function. Based on identifying the function, query analyzation module 104 may determine whether the query is suitable for optimization. For example, query analyzation module 104 may determine that the query may not be optimized when query analyzation module 104 identifies only holistic functions in the query. In some instances, query analyzation module 104 may generate the first sub-query or the second sub-query based on identifying one or more functions.

As illustrated, query optimization system 102 may also include data capturing module 108. In various embodiments, data capturing module 108 is configured to capture a proposed database query from user device 112. In various embodiments, software module 114 may include an application programming interface (API) to capture input (e.g., a proposed database query) and transmit the input to data capturing module 108. Data capturing module 108 may then provide the input to any of the components of environment 100, such as query analyzation module 104.

In some embodiments, a system or device other than the query optimization system 102 is used to generate or train one or more machine-learning models. For example, such a system may include instructions for generating the machine-learning model, the training data and ground truth, or instructions for training the machine-learning model. A resulting trained-machine-learning model may then be provided to the query optimization system 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training or used to validate the trained machine-learning model, e.g., compare the output of the trained model with the ground truth for that portion of the training data to evaluate an accuracy of the trained model. The training of the machine-learning model may be configured to cause the machine-learning model to learn associations, for example, between database queries and data stored in one or more databases.

In various embodiments, the variables of a machine-learning model may be interrelated in any suitable arrangement in order to generate the output. For example, in some embodiments, the machine-learning model may include content-processing architecture that is configured to identify, isolate, or extract features, geometry, and or structure in one or more of optical character recognition data or non-optical in vivo image data. For example, the machine-learning model may include one or more convolutional neural network (“CNN”) configured to identify patterns in database queries, data stored in one or more databases, intermediate results, final results, or the like. Similarly, the machine-learning model may include further architecture, e.g., a connected layer, neural network, etc., configured to determine a relationship between the identified patterns in order to output final result to a user query.

For example, in some embodiments, query analyzation module 104 of the query optimization system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model or Sequence to Sequence (“Seq2Seq”) model. An LSTM model may be configured to generate an output from a sample that takes at least some previous samples or outputs into account. A Seq2Seq model may be configured to, for example, receive a sequence of database queries or execution overhead data as input, and generate a query execution score as output.

Although depicted as separate components in FIG. 1, it should be understood that a component or portion of a component in the environment 100 may, in some embodiments, be integrated with or incorporated into one or more other components. For example, a display may be integrated into the user device 112 or the like. In another example, the query optimization system 102 may be integrated in a data storage system. The data storage system may be configured to communicate or receive/send data across electronic network 110 to other components of environment 100. Further, query optimization system 102 may be integrated or incorporated into software module 114. In some embodiments, operations or aspects of one or more of the components discussed above may be distributed amongst one or more other components. Any suitable arrangement or integration of the various systems and devices of the environment 100 may be used.

Further aspects of the machine-learning model or how it may be utilized are discussed in further detail in the methods below. In the following methods, various acts may be described as performed or executed by a component from FIG. 1, such as query optimization system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, or rearranged in any suitable manner.

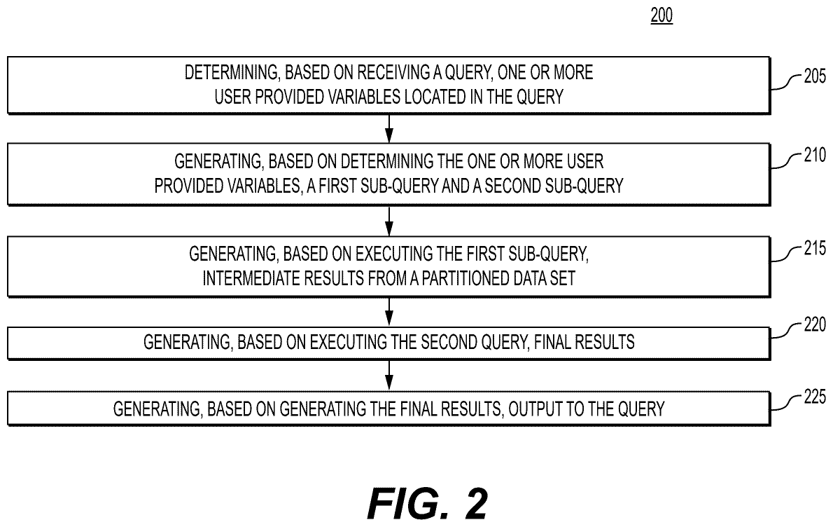

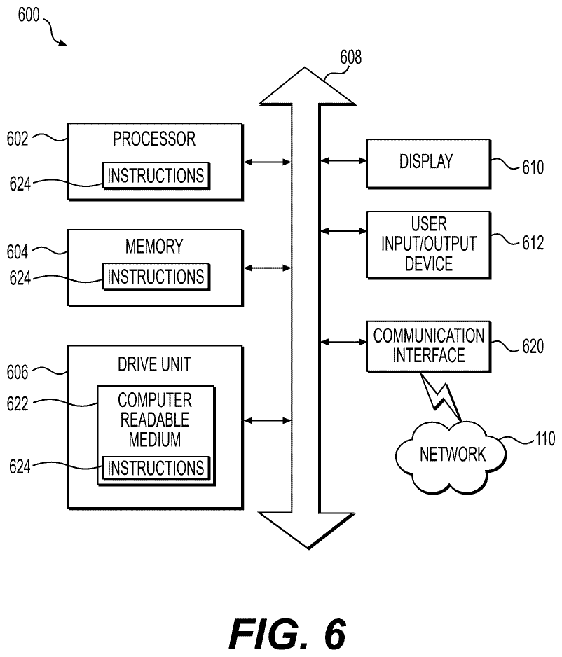

FIG. 2 illustrates a flowchart of an exemplary method 200 of optimizing a query, according to one or more embodiments. In some aspects, the method 200 may be performed by the query optimization system 102, which may include computer system 600 described with reference to FIG. 6 below.

At step 205, the method 200 may include determining, based on receiving a query, one or more user provided variables located (or contained) in the query. For example, a query, such as an SQL query, may be received at query optimization system 102 (e.g., via data capturing module 108). The query may be analyzed to determine whether the query contains one or more user provided variables. Query analyzation module 104 may employ one or more machine-learning models, neural networks, artificial intelligence, and other systems that analyze data to determine whether the query contains one or more user provided variables. For example, query analyzation module 104 may employ one or more natural language processing (NLP), object character recognition (OCR), computer vision, large language model (LLM), or other similar processes.

In some instances, the query analyzation module 104 may determine whether the query includes one or more functions. Each of the one or more user provided variables may be associated with a function. In SQL, these functions may include clauses or operators such as WHERE, SELECT, FROM, GROUP BY, HAVING, ORDER BY, LIMIT, OFFSET, and similar commands. Additionally, the functions may include BETWEEN, IN, LIKE, and similar operations.

Further, query analyzation module 104 may determine whether the one or more functions included in the query are a distributive function, an algebraic function, or a holistic function. A distributive function may be defined as a function F such that there is some function G such that F(B)=G(F(B1), F(B2), . . . . F(BN)), for data B composed of multiple partitions B1 . . . . BN. In other words, a function is distributive if the function may execute on each partition of a data set and get the correct value when aggregating all of them. For example, SUM and COUNT are distributive functions. COUNT may be distributive when executed by running SUM on intermediate results. Here, for example, F may be COUNT and G may be SUM.

An algebraic function may be defined as a function F that has a single function G that takes a finite number of arguments H that are each a distributive function. One example of an algebraic function is AVERAGE. To calculate AVERAGE, query analyzation module 104 may calculate both the SUM and COUNT of each partition, aggregate those results, and then divide the total sum by the total count.

A holistic function may be defined as a function that cannot be derived by performing a finite number of distributive functions on each partition. One example may be MEDIAN. Calculating the MEDIAN may require information for every value available. Hence, the whole data may be required to be available within a single node to calculate MEDIAN. When the method determines the query includes only holistic functions, query analyzation module 104 may decide to forgo optimizing and run the query (e.g., to run the originally received query without modification).

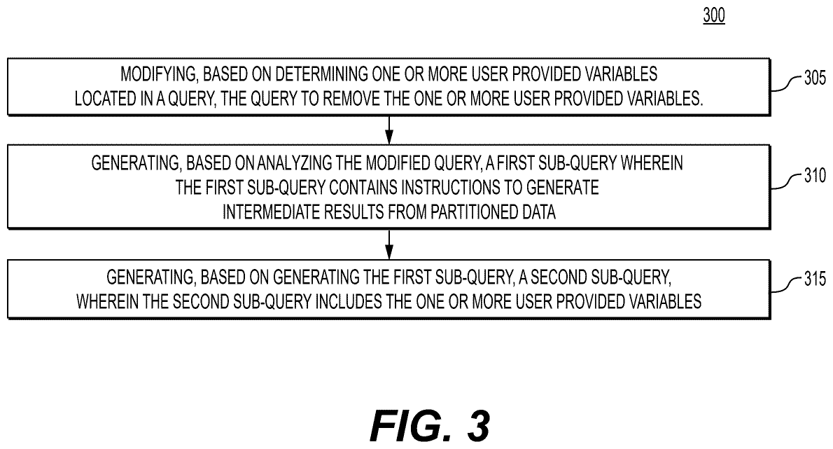

At step 210, the method 200 may include generating, based on determining the one or more user provided variables, a first sub-query and a second sub-query. For example, after determining that the query contains one or more user provided variables, query analyzation module 104 may analyze the query to generate a first sub-query and a second sub-query. Generating the first sub-query and the second sub-query is discussed in FIG. 3, below.

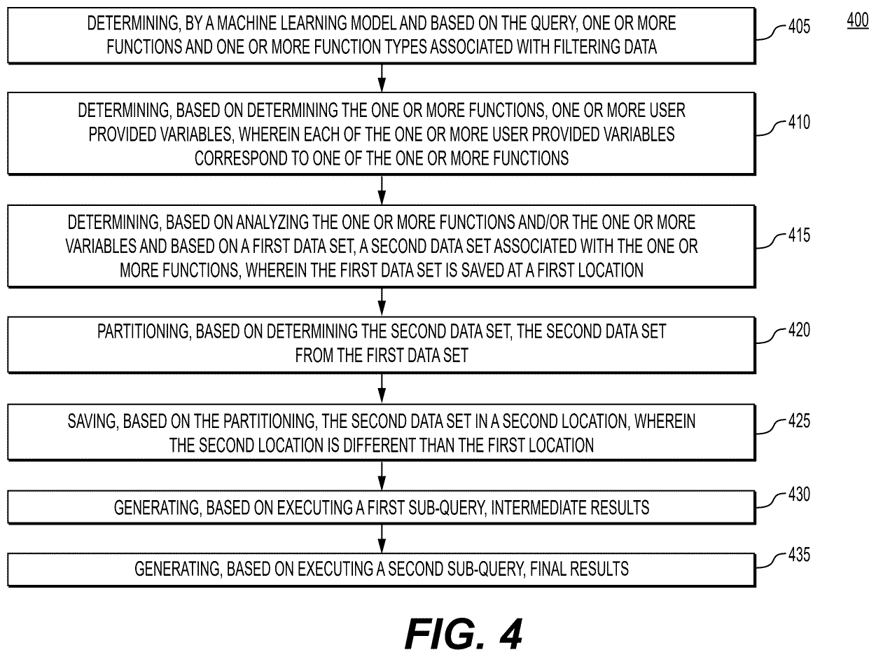

At step 215, the method 200 may include generating, based on executing the first sub-query, intermediate results from a partitioned data set. For example, query analyzation module 104 may execute the first sub-query and, based on executing the first sub-query, query analyzation module 104 may generate intermediate results 122. The intermediate results 122 may be generated based on partitioned data, as described in FIG. 4, below. Additionally or alternatively, executing the first sub-query may include partitioning data from one or more databases, as described in FIG. 4 below, then generating intermediate results 122. The intermediate results 122 may be stored at datastore 120.

At step 220, the method 200 may include generating, based on executing the second query, final results. For example, query analyzation module 104 may execute the second sub-query based on executing the first sub-query. Based on executing the second sub-query, query analyzation module 104 may calculate final results based on the intermediate results, by filtering out irrelevant data partitions, joining the remaining data partitions, and generating final results. Query analyzation module 104 may format the final results and then output the formatted final results.

At step 225, the method 200 may include generating, based on generating the final results, output to the query. For example, the query analyzation module 104 may output (transmit) the final results to a device, e.g., user device 112. The device may be an electronic user device, such as those described herein. Further, the user device 112 may host a software developer's environment, and the final results may be output through the environment.

FIG. 3 illustrates a flowchart of an exemplary method of generating sub-queries, according to one or more embodiments discussed above. In some aspects, the method 300 may be performed by the query optimization system 102. Further, the method 300 may be operated with computer system 600 in FIG. 6, below.

At step 305, the method 300 may include modifying, based on determining one or more user provided variables located in a query, the query to remove the one or more user provided variables. For example, after receiving the query and determining that the query contains one or more user provided variables, query analyzation module 104 may modify the query to remove the one or more user provided variables. Query analyzation module 104 may employ one or more machine-learning models, neural networks, artificial intelligence, and other systems described above to analyze and remove the one or more user provided variables. The one or more user provided variables may be saved to datastore 120. Query analyzation module 104 may generate a modified query which lacks (or excludes) the user provided variables. Removing the one or more user provided variables may include removing one or more commands, functions, expressions, or clauses associated with the one or more user provided variables.

At step 310, the method 300 may include generating, based on analyzing the modified query, a first sub-query wherein the first sub-query contains instructions to generate intermediate results from partitioned data. For example, query analyzation module 104 may employ one or more machine-learning models, neural networks, artificial intelligence, or other systems listed above to analyze the modified query. The first sub-query may comprise one or more first sub-queries or one or more nested queries. In some instances, the first sub-query may be based within a runtime clause. Query analyzation module 104 may generate the first sub-query to include instructions to identify a partitioned data set based on analyzing the modified query. The partitioned data set may be associated with the user provided variables. Executing the generated first sub-query may generate intermediate results, as described in FIG. 4. Query analyzation module 104 may save the first sub-query to, for example, datastore 120.

In some instances, the first sub-query may include instructions to generate intermediate results from partitioned data. The first sub-query may identify previously partitioned data and generate the intermediate results from the previously partitioned data. Additionally or alternatively, the first sub-query may identify data dependent on the one or more functions, partition the identified data, and save the partitioned data to a database, for example datastore 120. The partitioned data may include intermediate results from previously calculated data. The previously calculated data may be calculated based on information associated with the user provided variables. For example, the information may be associated with one or more functions located in the query. The first sub-query may not contain the user provided variables.

At step 315, the method 300 may include generating, based on generating the first sub-query, a second sub-query, wherein the second sub-query includes the one or more user provided variables. For example, query analyzation module 104 may generate the second sub-query based on analyzing the modified query. Additionally or alternatively, query analyzation module 104 may generate the second sub-query based on generating the first sub-query. The second sub-query may comprise one or more second sub-queries or nested sub-queries. Alternatively, query analyzation module 104 may generate the first sub-query and the second sub-query before partitioning data. The second sub-query may include the user provided variables. Further, the second sub-query may be a runtime query. Query analyzation module 104 may save the second sub-query to datastore 120.

Query analyzation module 104 may run a check to ensure that partitioning data may be optimal. For example, Query analyzation module 104 may add a check for SELECT COUNT (*) FROM ( ) on the original query and on the generated sub-queries. Query analyzation module 104 may determine, by comparing the two results, that the reduction of data reaches a predetermined threshold. Based on satisfying the predetermined threshold, query analyzation module 104 may save to library 124 or datastore 120 the generated first sub-query, the generated second sub-query, and the partitioned data. Query analyzation module 104 may retrieve data saved to library 124 or datastore 120 during future query analysis. Further, based on satisfying the predetermined threshold, query analyzation module 104 may determine to continue the optimization method.

In some instances, query analyzation module 104 may first determine that a query includes a WHERE clause. However, the WHERE clause may include multiple clauses joined by an AND (e.g., WHERE city=$some_variable AND state=‘CO’). Query analyzation module 104 may divide the multiple clauses into separate clauses (city=$some_variable AND state=‘CO’). Query analyzation module 104 may identify one clause to contain a user provided variable (e.g., state=‘CO’). Query analyzation module 104 may remove the user provided variable thereby generating a modified request. Query analyzation module 104 may identify one or more databases for each separate clause. Then, for clauses that include a variable (e.g., city=$some_variable), query analyzation module 104 may search through data identifying information, such as columns, containing relative information (e.g., “city”). Query analyzation module 104 may mark these columns for columns for partitioning.

In other instances, query analyzation module 104 may receive a query: SELECT SUM (a), b FROM table WHERE c=$my_variable AND d=‘my-value’ GROUP BY b. Upon determining the query includes one or more user provided variables, query analyzation module 104 may generate a first sub-query to prepare data: CREATE TABLE prequery AS (SELECT SUM (a), b, c FROM table WHERE d=‘my-value’ GROUP BY b, c). Query analyzation module 104 may generate a second sub-query to execute a final result to the query: SELECT SUM (a), b FROM prequery WHERE c=$my_variable. Query analyzation module 104 may dramatically reduce the size of the data needed for the second sub-query to generate the results, as compared to running the original query, while allowing for dynamic behavior.

FIG. 4 illustrates a flowchart of an exemplary method of generating partitioned data and intermediate results, according to one or more embodiments. In some aspects, the method 400 may be performed by the query optimization system 102. Further, the method 400 may be operated with computer system 600 in FIG. 6, below.

At step 405, the method 400 may include determining, by a machine learning model and based on the query, one or more functions and one or more function types associated with filtering data. For example, query analyzation module 104 may identify one or more functions and function types that filter data. Query analyzation module 104 may analyze the query or the modified query to determine the one or more functions. In determining the one or more functions, query analyzation module 104 may determine a function type of each of the one or more functions. For example, the function type may include a first function type, a second function type, and a third function type. The first function type may be associated with a distributive function. The second function type may be associated with an algebraic function. The third function type may be associated with a holistic function. Query analyzation module 104 may use the intermediate results from step 205 above to identify the one or more functions and one or more function types associated with filtering data. The one or more functions may include the functions listed above. Query analyzation module 104 may employ one or more machine learning models, as described above in FIG. 1, to determine the one or more functions associated with filtering data. The one or more functions may include one or more SQL commands or one or more SQL functions.

At step 410, the method 400 may include determining, based on determining the one or more functions, one or more user provided variables, wherein each of the one or more user provided variables correspond to one of the one or more functions. For example, query analyzation module 104 may determine one or more user provided variables included in the query. Each of the one or more user provided variables may correspond to one or more functions. Query analyzation module 104 may employ one or more machine learning models, as described above, to determine the one or more user provided variables included in the query.

At step 415, the method 400 may include determining, based on analyzing the one or more functions or the one or more variables and based on a first data set, a second data set associated with the one or more functions, wherein the first data set is saved at a first location. For example, query analyzation module 104 may, after analyzing the one or more functions or the one or more variables and based on a first data set, determine a second data set associated with the one or more functions. The first data set may be saved at a first location. The first data set may be a total data set and may contain all relevant data associated with query. The first data set may be stored at datastore 120 and transmitted to query optimization system 102 via electronic network 110. The second data set may contain all data associated with the one or more functions or one or more variables. The second data set may be determined based on information associated with the one or more functions or the one or more variables. Information associated with the one or more functions or the one or more variable may include locations of data in a spreadsheet, database, or the like.

At step 420, the method 400 may include partitioning, based on determining the second data set, the second data set from the first data set. For example, query analyzation module 104 may partition the second data set from the first data set, based on determining the second data set. Partitioning may include flagging data for future use, e.g., flagging columns or rows. In some instances, query analyzation module 104 may partition data by using GROUP BY with relevant columns. Further, query analyzation module 104 may partition data into single-partition columns, ordinal partitions, and categorical partitions. For single-partition columns, query analyzation module 104 may determine ahead of time all possible partitions and generate them. For ordinal partitions, query analyzation module 104 may group variables according to an order associated with the variables, allowing analyzation of the partition based on the order of the variables. Categorical partitions may partition data based on analyzing the one or more functions in the query, then combine any number of partitions associated with the query using, for example, GROUP BY.

Partitioning may include generating one or more spreadsheets, tables, databases, or the like. Partitioning may include joining or combining one or more previously partitioned data. In some cases, query analyzation module 104 may generate the partitioned data before receiving the query. Query analyzation module 104 may partition data at step 305, before generating the first sub-query. Additionally or alternatively, query analyzation module 104 may partition data, based on receiving the query, at step 205. Additionally or alternatively, query analyzation module 104 may generate partitioned data after executing the first sub-query at step 215. Query analyzation module 104 may dynamically generate partitioned data based on the received query. Further, the partitioned data may be aggregated without limiting the functionality of the query. Query analyzation module 104 may recognize a specific pattern of aggregation. Based on recognizing the specific pattern of aggregation, query analyzation module 104 may create and store additional storage structures, such as columns and rows, to support the specific pattern of aggregation.

At step 425, the method 400 may include saving, based on the partitioning, the second data set in a second location, wherein the second location is different than the first location. For example, query analyzation module 104 may save the partitioned data at a second location. The second location may be different than the first location. For example, the first data set may be saved at datastore 120 while the second data set may be stored within the query optimization system 102. Alternatively, the first data set may be stored in a first library and the second data set may be stored at a second library.

Alternatively, information associated with the partitioned data may be saved to a second location. The second location may be the same location as the first location. Information associated with the partitioned data may include, for example, flagged information.

At step 430, the method 400 may include generating, based on executing a first sub-query, intermediate results. For example, query analyzation module 104 may generate intermediate results based on executing the first sub-query. Executing the first sub-query may generate intermediate results by retrieving the partitioned data set and calculating all possible outputs as intermediate results. Additionally or alternatively, the intermediate results may be calculated by aggregating the partitioned data. Additionally or alternatively, the first sub-query may first generate partitioned data then calculate the intermediate results. Query analyzation module 104 may generate intermediate results based on the partitioned data set and the one or more functions. In some instances, query analyzation module 104 may retrieve pre-generated intermediate results from, for example, datastore 120. Optionally, query analyzation module 104 may save the intermediate results, such as in datastore 120. In this way, query analyzation module 104 may improve query speed and reduce computational load. Further, query analyzation module 104 may reduce the amount of data transferred over electronic network 110. Query analyzation module 104 may transmit the intermediate results to user device 112. Additionally or alternatively, user device 112 may execute the first sub-query and generate intermediate results.

At step 435, the method 400 may include generating, based on executing a second sub-query, final results. For example, query analyzation module 104 may generate final results to the query based on executing a second sub-query. The second sub-query may contain the user provided variables, and query analyzation module 104 may generate the final results based on the user provided variables and the intermediate results. Alternatively, a user may input one or more user provided variables into user device 112 or datastore 120. Query analyzation module 104 may receive the user provided variables from user device 112 or datastore 120. Alternatively, user device 112 or other processing device may generate the final results, as described above.

In some instances, to generate final results, query analyzation module 104 may filter out irrelevant partitions. Additionally, query analyzation module 104 may join one or more partitioned data sets and apply the user provided variables to generate the final results. After generating the final results, Query analyzation module 104 may output the final results in one or more spreadsheets, tables, databases, or the like. Query analyzation module 104 may format the one or more spreadsheets, tables, databases, or the like to output the generated final results. For example query analyzation module 104 may eliminate unused columns and rows. Additionally or alternatively, user device 112 may execute the second sub-query and generate final results.

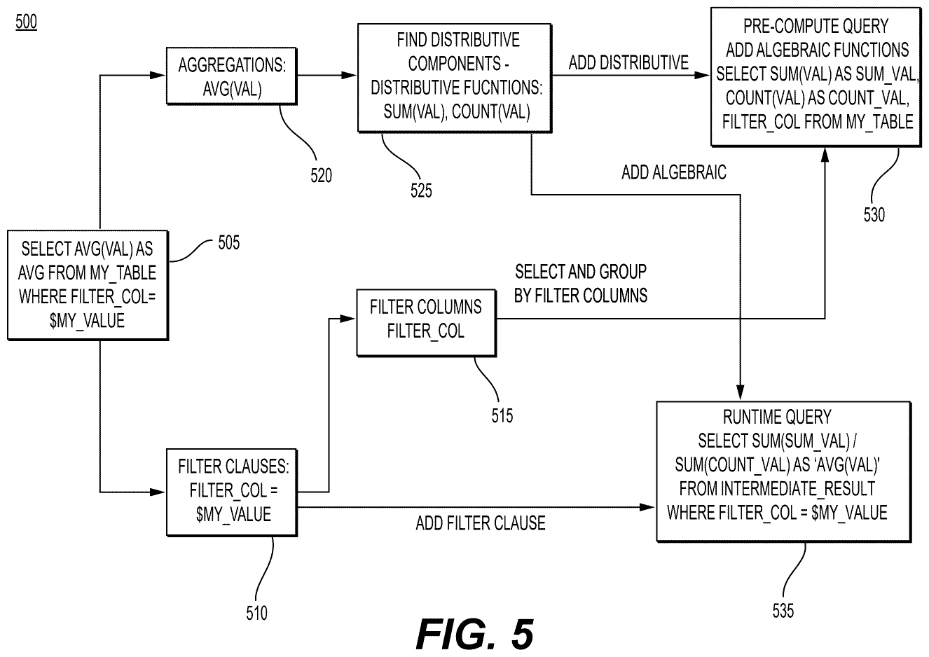

FIG. 5 a flowchart of an exemplary method of generating final results, according to one or more embodiments. In some aspects, the method 500 may be performed by the query optimization system 102. Further, the method 500 may be operated with computer system 600 in FIG. 6, below.

At step 505, query analyzation module 104 may receive, from data capturing module 108, the following query: SELECT AVG (val) AS AVG FROM my_table WHERE filter_col=$my_value and identify relevant data, for example the following table:

| val | filter_col |
|---|---|
| 12 | a |
| 7 | b |
| 19 | c |
| 15 | a |
| 8 | b |
| 2 | c |
| 5 | a |
| 11 | b |
| 14 | c |

At step 510, query analyzation module 104 may determine one or more clauses that filter data. Query analyzation module 104 may determine a WHERE clause. Further analysis may determine filter_col=$my_value at the WHERE clause. Query analyzation module 104 may determine a variable in the clause: $my_value.

At step 515, query analyzation module 104 may determine only one column in the clause: filter_col. Query analyzation module 104 may determine to partition the data based on the column, filter_col.

At step 520, query analyzation module 104 may determine intermediate results. Query analyzation module 104 may analyze the data partitioned by filter_col and begin the initial steps of AVG (val).

At step 525, query analyzation module 104 may determine that AVG may be an algebraic function composed of two distributive functions: COUNT (val) and SUM (val). Therefore, query analyzation module 104 may calculate the COUNT and SUM of val for each partition—for each value of filter_col. The intermediate results may be stored, for example, in the table below:

| Sum_val | count_val | Filter_col |
|---|---|---|
| 54 | 5 | b |
| 46 | 5 | a |
| 61 | 5 | c |

At step 530, query analyzation module 104 may execute a first sub-query. For example, the first sub-query may include the query: run SELECT SUM (val) AS sum_val, COUNT (val) AS count_val, filter_col FROM my_table GROUP BY filter_col. Alternatively, query analyzation module 104 may transmit the first sub-query to user device 112. User device 112 may run the first sub-query on software module 114.

At step 535, query analyzation module 104 may execute a second sub-query. Alternatively, query analyzation module 104 may transmit the second sub-query to user device 112. User device 112 may execute the second sub-query on software module 114.

When executing the second sub-query, query analyzation module 104 may determine a value for $my_value—e.g., “c”. Query analyzation module 104 may analyze intermediate results, filter for relevant partitions, and determine the final results. Here, query analyzation module 104 may execute SELECT SUM (sum_val)/SUM (count_val) AS “AVG (val)” FROM intermediate_result WHERE filter_col=‘c’. The final results may be output, for example, in the table below:

avg(val)
12.2

Notably, the second step may produce increased performance benefits. For example, if a target data set (second data set) includes 5 M rows of 1 KB each, the original data set (first data set) may be 5 GB. The query output may include only three columns, each 4 bytes, and only 1k rows. Hence, query analyzation module 104 may turn a 5 GB data set into a 4 KB data set without extra engineering effort.

Additionally, the partitions may be stored separately in datastore 120, library 124, or the like. Therefore, query analyzation module 104 may only need to retrieve the relevant portioned (partitioned) data. Alternatively, query analyzation module 104 may receive relevant portioned (partitioned) data from executing the first sub-query. In the above example, this process may turn the data set required to run the query from 4 KB to 12B of data, not taking into account metadata.

Query analyzation module 104 may create or modify one or more tables, databases, spreadsheets, or similar structure without variables during the process. For example, query analyzation module 104 may be provided with query: SELECT a, b FROM my_table WHERE c=10. Query analyzation module 104 may create a new table with these two values and may remove extraneous columns or rows: CREATE TABLE prequery AS (SELECT a, b FROM my_table WHERE c=10). At runtime, query analyzation module 104 may load the data into the prequery table: SELECT a, b FROM prequery.

In some instances, query analyzation module 104 may analyze the query to intelligently filter data before executing a second sub-query. For example, query analyzation module 104 may analyze the query: SELECT a, b FROM table WHERE c=$my_var AND d=‘example’. Even with the variable $my_var, query analyzation module 104 may filter out a large amount of data, e.g., eliminate large numbers of rows. Further, since the result of (d=‘example’) does not depend on any variables, query analyzation module 104 may evaluate it during a first sub-query. For example, query analyzation module 104 may generate a first sub-query: CREATE TABLE prequery AS (SELECT a, b, c FROM my_table WHERE d=‘example’). Query analyzation module 104 may then generate and execute a second sub-query: SELECT a, b FROM prequery WHERE c=$my_var. The values may be passed in as SQL variables to JSON values, or other format as necessary for optimization.

Further, query analyzation module 104 may provide for aggregate variable queries. For example, query analyzation module 104 may receive the query SELECT SUM (a), b FROM my_table WHERE c=$my_var GROUP BY b. Implementing the previous pre-query here would not produce efficient results. The number of rows in the resulting table would be equal to the number of rows in the original table. If there are n number of rows per unique value of b, query analyzation module 104 may miss out on an n times increased speed in executing queries. Therefore, this example demonstrates the necessity of dynamically generating the first sub-query based on the unique features of the original query. Here, for example, query analyzation module 104 may add the column being compared to the variable to the GROUP BY clause, and then specify which result required at runtime (executing the second sub-query). For example, query analyzation module 104 may generate a first sub-query: CREATE TABLE prequery AS (SELECT SUM (a), b, c FROM my_table GROUP BY b, c). Then, query analyzation module 104 may generate a second sub-query: SELECT “SUM (A)”, b FROM prequery WHERE c=$my_var.

Query analyzation module 104 may accommodate for the situation where a number of rows in the resulting table would be equal to the number of rows in the original table. If there are n number of rows per unique value of b, query analyzation module 104 may miss out on n times increased speed in queries. To solve this, query analyzation module 104 may add the column being compared to the variable to the GROUP BY clause and then specify an interested result at runtime. For example, query analyzation module 104 may generate a pre-compute query (first sub-query) as CREATE TABLE prequery AS (SELECT SUM (a), b, c FROM my_table GROUP BY b, c). Further, query analyzation module 104 may generate a runtime query (second sub-query) as SELECT “SUM (A)”, b FROM prequery WHERE c=$my_var.

In some instances, query analyzation module 104 may provide for more complicated conditions for aggregate queries, such as data ranges. For example, query analyzation module 104 may receive the query SELECT COUNT (a), b FROM table WHERE c>$lower bound AND c<$upper_bound GROUP. As aggregating the values at runtime returns a O(n2) number of possible ranges the user could provide (where n may be the number of values for c), query analyzation module 104 may provide an additional aggregate at runtime to aggregate all of the different values of c for each value of b. For example, query analyzation module 104 may involve one or more distributive or algebraic functions. Here, SUM may be a distributive function. Query analyzation module 104 may group by both b and c, then combine the outputs for only the values of c desired at runtime. For example, the first sub-query may be generated as CREATE TABLE prequery AS (SELECT COUNT (a), b, c FROM my_table GROUP BY b, c) and the second sub-query (the runtime query) may be generated as SELECT SUM (“COUNT (A)”) AS “COUNT (A)”, b FROM prequery WHERE c>$lower_bound AND c<$upper_bound GROUP BY b.

Query analyzation module 104 may provide for algebraic functions by calculating the constituent distributive functions at workflow-time. For example, query analyzation module 104 may receive the query SELECT AVERAGE (a), b FROM my_table WHERE c>$lower bound AND c<$upper_bound. Query analyzation module 104 may extract the constituent distributive functions of AVERAGE (specifically, SUM and COUNT) before computing the final values and calculating those at runtime. For example, query analyzation module 104 may generate a first sub-query: CREATE TABLE prequery AS (SELECT SUM (A) AS “PartitionSum”, COUNT (A) AS “PartitionCount”, b, c FROM my_table GROUP BY b, c). Query analyzation module 104 may generate a second sub-query: SELECT SUM (PartitionSum)/SUM (PartitionCount) AS “AVERAGE (a)”, b FROM prequery WHERE c>$lower_bound AND c<$lower bound GROUP BY b. This process may allow the method to create and combine any partition for any algebraic or distributive function. Further, query analyzation module 104 may simplify the approach by dividing up aggregate queries into their distributive components.

In some instances, query analyzation module 104 may provide for queries with variable nested queries. For example, query analyzation module 104 may receive the query SELECT a FROM table WHERE b IN (SELECT some_col FROM table WHERE other_col=$m). Query analyzation module 104 may treat the nested query as a separate query to optimize in the same manner. Query analyzation module 104 may treat any clause that contains a nested query with a value as a clause that otherwise contains a variable. Query analyzation module 104 may turn the above query into multiple pre-compute queries, before combining them at runtime. For example, Query analyzation module 104 may generate two pre-compute queries (first sub-queries A and B) such as (A) CREATE TABLE prequery AS (SELECT a, b FROM my_table) and (B) CREATE TABLE presubquery AS (SELECT some_col, other_col FROM my_table). Query analyzation module 104 may generate a second sub-query: SELECT a FROM prequery WHERE b IN (SELECT some_col FROM presubquery WHERE other.

Further clauses may require analysis before generating the first sub-query and the second sub-query. For example, the HAVING clause may require knowledge of the aggregated values of a given group; query analyzation module 104 may filter these clauses at runtime. The ORDER BY clause may be executed at runtime; however depending on the sorting algorithm implemented, query analyzation module 104 may pre-sort values for improved performance. The clauses LIMIT and OFFSET may be optimized depending on runtime filtering.

As illustrated above, query analyzation module 104 may analyze clauses independently to dynamically generate one or more first sub-queries and one or more second sub-queries. A clause may take a list of expressions. These expressions may be references to columns, scalar functions, aggregate functions, or a combination of the three (e.g., SUM (val)/COUNT (val)). Query analyzation module 104 may analyze these expressions in three steps.

In a first step, query analyzation module 104 may determine one or more columns referenced outside of an aggregate function. Query analyzation module 104 may add each expression to a SELECT clause of the pre-compute query (first sub-query). In a second step, query analyzation module 104 may identify one or more aggregate functions that are being performed in the query, then determine whether one or more holistic functions are present. When the method determines the presence of one or more holistic functions, query analyzation module 104 may identify all columns referenced in aggregate queries and add those to a SELECT clause of the first sub-query. This may indicate to the method that the first sub-query must be executed holistically. When the method determines that one or more holistic functions are not present, query analyzation module 104 may convert each aggregate function into a set of distributive functions then add the distributive functions to a SELECT clause of a first sub-query. In a third step, query analyzation module 104 may add each expression to the query, replacing any aggregate functions with the composition of the distributive functions calculated in the second step. Further steps may be added to process clauses, e.g., query analyzation module 104 may evaluate one or more scalar functions in a first sub-query clause to minimize runtime.

Query analyzation module 104 may process FROM clauses by keeping the FROM clause the same in the first sub-query. In the second sub-query, query analyzation module 104 may convert the clause to a pre-query. In this way, query analyzation module 104 may automatically process any JOINs during a multi-table approach.

As demonstrated above, query analyzation module 104 may provide for queries including WHERE clauses. A WHERE clause may take a single Boolean expression. Query analyzation module 104 may optimize these queries by first determining whether the expression includes a variable. When the method determines that the query includes a variable (e.g., a user provided variable), Query analyzation module 104 may identify one or more columns referenced (data depending on the clause). Query analyzation module 104 may generate a first sub-query by adding information associated with the variables to a SELECT and a GROUP BY clause. Query analyzation module 104 may generate a second sub-query by adding a WHERE clause to the second sub-query expression. When the method determines that the query does not include a variable, query analyzation module 104 may add the clause to the first sub-query and remove the clause from the second sub-query.

Query analyzation module 104 may intelligently analyze one or more operators. For example, “a” AND “b” AND “c” cannot be true if “a” or “b” or “c” is false. Therefore, query analyzation module 104 may treat each expression as an independent WHERE clause. In the instance that only “a” contains an expression, query analyzation module 104 may determine that the columns within “a” need to be grouped. Further, “b” and “c” may be computed in the first sub-query step. In some instances, query analyzation module 104 may use SELECT to go a step further and pre-compute one or more expressions.

Query analyzation module 104 may determine whether the query includes a holistic clause. When the query determines one or more holistic clauses, query analyzation module 104 may group the holistic clauses in the second sub-query. If the method determines that the query includes clauses that are not holistic clauses, query analyzation module 104 may inert the non-holistic clauses in one or more first sub-queries. If the method determines the query includes only holistic clauses, query analyzation module 104 may determine not to optimize.

Query analyzation module 104 may determine whether the query includes a WHERE clause. When the query determines that the query includes a WHERE clause, query analyzation module 104 may determine to add additional expressions to one or more pre-compute queries (first sub-queries). The additional expressions may be associated with the WHERE clause.

Query analyzation module 104 may determine whether the query includes one or more of HAVING, ORDER BY, LIMIT, OFFSET, or similar clauses. When the method determines that the query includes one or more HAVING, ORDER BY, LIMIT, OFFSET, or similar clauses, query analyzation module 104 may include the one or more HAVING, ORDER BY, LIMIT, OFFSET, or similar clauses in the second sub-query.

After generating the second sub-query, query analyzation module 104 may analyze the generated second sub-query to determine whether the second sub-query clauses include nested queries. When the method determines that one or more second sub-query clauses include one or more nested queries, query analyzation module 104 may generate a first sub-query and a second sub-query for a first nested query S. Next, query analyzation module 104 may add the first sub-query S to a global pre-compute (first sub-query) query. Finally, query analyzation module 104 may replace the reference to S within a global second sub-query with the emitted second sub-query of S.

Query analyzation module 104 may communicate with one or more libraries. For example, query analyzation module 104 may save the generated first sub-queries and second sub-queries to a library, such as library 124. Additionally, query analyzation module 104 may run sub-queries in a workflow, save the results to a cloud such as electronic network 110. The data may load from an API, such as software module 114, when the user executes the query on user device 112.

FIG. 6 is a simplified functional block diagram of a computer system 600 that may be configured as a device for executing the methods disclosed here, according to exemplary embodiments of the present disclosure. For example, the computer system 600 may be configured as a system according to exemplary embodiments of this disclosure, In various embodiments, any of the systems herein may be a computer system 600 including, for example, a data communication interface 620 for packet data communication. The computer system 600 also may include a central processing unit (“CPU”) 602, in the form of one or more processors, for executing program instructions. The computer system 600 may include an internal communication bus 608, and a storage unit 606 (such as ROM, HDD, SDD, etc.) that may store data on a computer readable medium 622, although the computer system 600 may receive programming and data via network communications. The computer system 600 may also have a memory 604 (such as RAM) storing instructions 624 for executing techniques presented herein, although the instructions 624 may be stored temporarily or permanently within other modules of computer system 600 (e.g., CPU 602 or computer readable medium 622). The computer system 600 also may include input and output ports 612 or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the processes illustrated in FIGS. 2, 3, 4, and 5 may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A method comprising:
determining, by a query analysis module and based on receiving a query, one or more user provided variables located in the query, wherein the query analysis module includes a machine learning module;
generating, by the query analysis module and based on determining the one or more user provided variables, a first sub-query and a second sub-query by:
modifying the query to remove the one or more user provided variables;
storing the removed one or more user provided variables in a datastore;
analyzing the modified query to determine one or more functions, wherein the one or more functions are configured to filter data;
generating, based the one or more functions, the first sub-query, wherein the first sub-query comprises includes instructions to retrieve a partitioned data set with pre-calculated intermediate results;
retrieving the removed one or more user provided variables from the datastore; and
generating, based on generating the first sub-query and based on the retrieved one or more user provided variables, the second sub-query;
generating, by the query analysis module, intermediate results by executing the first sub-query and using the retrieved partitioned data sets;
executing, by the query analysis module, the second sub-query; and
based on executing the second sub-query and based on the intermediate results, providing output to the query.

2. The method of claim 1, generating the first sub-query and the second sub-query further includes:
determining a function type of the one or more functions located in the query, where the function type includes one of a first function type, a second function type, or a third function type; and
based on determining the function type of the one or more functions, generating the first sub-query.

3. (canceled)

4. The method of claim 1, wherein the partitioned data set is generated by:
determining, based on applying the one or more functions to a first data set, a second data set associated with the one or more functions, wherein the first data set is saved at a first location;
partitioning, based on determining the second data set, the second data set from the first data set; and
saving, based on the partitioning, the second data set to a second location, wherein the second location is different than the first location.

5. The method of claim 1, wherein the partitioned data set with the pre-calculated intermediate results is generated by:
determining, based on applying the one or more functions to a first data set, a second data set associated with the one or more functions, wherein the first data set is saved at a first location;
partitioning, based on determining the second data set, the second data set from the first data set;
saving, based on the partitioning, the second data set to a second location, wherein the second location is different than the first location;
determining, based on the second data set and the one or more functions, intermediate results, wherein the intermediate results include a calculation for each data in the second data set; and
saving, based on the determining, the intermediate results at the second location.

6. The method of claim 1, wherein the user provided variables correspond to the one or more functions associated with filtering data.

7. The method of claim 1, wherein providing the output to the query comprises:
analyzing, based on executing the second sub-query, the intermediate results with the user provided variables; and
generating, based on the analyzing, the output to the query.

8. The method of claim 1, wherein retrieving the partitioned data set with the pre-calculated intermediate results comprises retrieving the partitioned data set from a library.

9. The method of claim 1, further comprising:
generating, based on executing the first sub-query, a first database, wherein the first database includes the partitioned data set with the pre-calculated intermediate results;
modifying, based on the generating and based on the first sub-query, the partitioned data with the pre-calculated results; and
saving, based on the modifying, the modified partitioned data with the pre-calculated results to a library.

10. A method comprising:
determining, by a query analysis module and based on receiving a query, that the query includes one or more user provided variables, wherein the query analysis module includes a machine learning module;
generating, by the query analysis module and based on determining the one or more user provided variables, a first sub-query and a second sub-query by:
modifying the query to remove the one or more user provided variables;
storing the removed one or more user provided variables in a first datastore;
determining, based on analyzing the modified query, a first data set associated with the one or more user provided variables;
partitioning, based on determining the first data set, the first data set;
analyzing the modified query to determine one or more functions, wherein the one or more functions are configured to filter data;
generating, based on the one or more functions, the first sub-query, wherein the first sub-query includes instructions to retrieve the partitioned data set and to calculate intermediate results with the first data set;
retrieving the removed one or more user provided variables from the first datastore; and
generating, based on generating the first sub-query and based on the retrieved one or more user provided variables, the second sub-query;
generating, by the query analysis module and based on executing the first sub-query, the intermediate results; and
based on executing the second sub-query and the intermediate results, providing output to the query.

11. The method of claim 10, wherein generating the first sub-query uses two or more machine-learning models.

12. The method of claim 10, wherein the partitioned data set includes the first data set associated with the one or more user provided variables.

13. The method of claim 10, further comprises: saving, based on generating the intermediate results, the intermediate results in a second datastore.

14. The method of claim 10, wherein determining the first data set comprises:
determining, based on the one or more functions, the first data set from a total data set; and
based on determining the first data set, storing the first data set in a second datastore.

15. The method of claim 14, wherein generating the partitioned data set comprises: retrieving, based on executing the first sub-query, the first data set from the second datastore.

16. The method of claim 10, wherein providing the output to the query comprises:
determining, based on executing the first sub-query, the intermediate results; and
determining, based on executing the second sub-query with the one or more user provided variables, the output to the query.

17. A computing system, comprising:
a processor; and
a memory having programming instructions stored thereon, which, when executed by the processor, cause the computing system to perform operations via a query analysis module associated with the processor, wherein the query analysis module includes one or more machine learning modules, the operations comprising:
determining, based on receiving a query, one or more user provided variables located in the query;
generating, based on determining the one or more user provided variables located in the query, a first sub-query and a second sub-query by:
modifying the query by removing the one or more user provided variables;
storing the removed one or more user provided variables in a datastore;
analyzing the modified query to determine one or more functions, wherein the one or more functions are configured to filter data;
generating, based on the modified query and based on the one or more functions, the first sub-query, wherein the first sub-query includes instructions to partition a data set;
retrieving the removed one or more user provided variables from the datastore; and
generating, based on generating the first sub-query and based on the retrieved one or more user provided variables, the second sub-query;
generating, based on executing the first sub-query, a partitioned data set;
generating, based on generating the partitioned data set, intermediate results; and
based on executing the second sub-query and based on generating the intermediate results, providing output to the query.

18. The computing system of claim 17, wherein the instructions, when executed by the processor, cause the computing system via the query analysis module to generate the partitioned data set by:
determining, based on applying the one or more functions to a first data set, a second data set associated with the one or more functions, wherein the first data set is saved at a first location;
partitioning, based on determining the second data set, the second data set from the first data set; and
saving, based on the partitioning, the second data set to a second location, wherein the second location is different than the first location.

19. The computing system of claim 17, further including a first machine learning model of the one or more machine learning modules and a second machine learning model of the one or more machine learning modules, wherein the first machine-learning model is a different model than the second machine-learning model.

20. The computing system of claim 17, wherein the instructions, when executed by the processor, cause the computing system to provide the output to the query via the query analysis module by:
generating, based on the intermediate results and the one or more user provided variables, final results as the output to the query.

21. The method of claim 2, wherein the first function type, the second function type, or the third function type includes a distributive function, an algebraic function, or a holistic function.
